(19) United States
(12) Patent Application Publication
(10) Pub. No.: US 2017/0203301 A1
(43) Pub. Date: Jul. 20, 2017

(54) COMMINUTION DEVICE AND METHOD FOR OPERATING SUCH A COMMINUTION DEVICE

(71) Applicant: intimus International GmbH, Markdorf (DE)

(72) Inventor: Javier Ortiz de Zárate, Vitoria (ES)

(73) Assignee: intimus International GmbH, Markdorf (DE)

(21) Appl. No.: 15/413,092

(22) Filed: Jan. 23, 2017

(30) Foreign Application Priority Data
Jan. 20, 2016 (DE) 102016200756.4

(51) Int. Cl. B02C 18/18; B02C 18/22; B02C 25/00

(52) U.S. Cl. CPC B02C 18/182; B02C 25/00; B02C 18/2291

(57) ABSTRACT

A comminution device for product for comminution such as memory cards or mobile terminal apparatuses has a comminution unit which has two interacting cutting rollers having cutting discs that have cutting edges on the external peripheral edges and form a cutting gap. The cutting discs of the one cutting roller each engage in an annular groove between adjacent cutting discs of the other cutting roller and along the external circumference have a plurality of teeth, each having one tooth tip and one tooth blade. The tooth blades of the one cutting roller during operation upon rotation of the cutting rollers each lie beside the tooth blades of the other cutting roller. The comminution unit yet has an infeed having an infeed track for the product for comminution to the comminution unit, said infeed track terminating above the cutting gap. An elongate piloting device which extends across a length of at least 30% of the length of the cutting rollers, and which in the longitudinal profile thereof slopes downward is disposed therebetween.

### CROSS-REFERENCE TO RELATED APPLICATION

The present application claims priority to German Patent Application No. 10 2016 200 756.4, filed Jan. 20, 2016, the entirety of which is incorporated herein by reference.

### FIELD OF APPLICATION AND PRIOR ART

The invention relates to a comminution device for product for comminution such as memory cards, mobile terminal apparatuses or the like, that is to say in particular relatively stable, flexurally rigid, and in part thick or voluminous, respectively, and potentially smooth product for comminution. The invention furthermore relates to a method for operating such a comminution device.

Various similar comminution devices, also referred to as shredders, are known from the prior art. Said comminution devices may not only be configured for comminuting paper but also for CDs, such as in the case of DE 19912036 A1, for example, or for various other media, such as in the case of DE 10008442 A1, for example. However, these comminution devices are not suitable for mobile terminal apparatuses such as mobile phones or tablet computers, for example.

### OBJECT AND ACHIEVEMENT

The invention is based on the object of providing a comminution device mentioned at the outset, and a method mentioned at the outset for operating the former, by way of which issues of the prior art may be avoided, and by way of which it is possible in particular for aforementioned product for comminution, in particular mobile terminal apparatuses, to be comminuted in a simple, positive, and reliable manner. It is particularly relevant herein that digital data that is stored in this product for comminution no longer may be accessed or used.

This object is achieved by a comminution device having the features of Claim 1, and by a method having the features of Claim 15. Advantageous and preferred design embodiments of the invention are stated in the further claims and will be explained in more detail hereunder. Herein, many of the features are described only in the context of the device, or only in the context of the method for operating the latter. However, irrespectively thereof, said features are intended to apply equally and independently to both the comminution device as well as to the method. The wording of the claims is incorporated in the description by way of explicit reference.

It is provided that the comminution device has a comminution unit that, in a manner substantially known per se, has two interacting cutting rollers that are rotatably driven in mutually opposite directions. The cutting rollers each have mutually intersecting or mutually engaging cutting discs, respectively, that are disposed in an alternating manner and that across the length of the cutting rollers conjointly form a so-called cutting gap. This cutting gap is that region in which the product for comminution comes into contact with both cutting rollers, the comminution of said product for comminution thus commencing. Here, cutting discs of the one cutting roller each engage in an annular groove between adjacent cutting discs of the other cutting roller. This engagement is in each case advantageously alternating. Particularly advantageously, except for the outermost cutting discs at each end of both cutting rollers, all cutting discs bear on two adjacent cutting discs of the opposite cutting roller. In this case, no wide open intermediate spaces or the like are then provided.

The cutting discs, in a manner known per se, at their external peripheral edges have cutting edges that interact with corresponding cutting edges of the cutting discs of the other cutting roller. Furthermore, the cutting discs along the external circumference have a plurality of teeth, for example 6 teeth to 20 teeth. Each tooth has one tooth tip and one tooth blade on this tooth tip. Advantageously, the teeth in the shape thereof are the same or, particular advantageously, even identical for all cutting discs, respectively.

According to the invention it is provided that the teeth or tooth blades, respectively, of the cutting discs are aligned such that the former during operation of the comminution unit, or of the comminution device, respectively, upon rotation of the cutting rollers in an operation direction each lie beside the teeth or the tooth blades, respectively, of the other cutting roller. This advantageously means that the cutting discs of the two cutting rollers mesh or engage, respectively, in a tooth-on-tooth manner, so to speak, as opposed to the manner as is provided to some extent in the prior art, in which the teeth of the cutting discs of the one cutting roller mesh in depressions between two teeth at the other cutting roller. By way of this advantageous meshing of the mutually opposite teeth, the stable and to some extent also smooth product for comminution mentioned at the outset, such as mobile terminal apparatuses, in particular, may be positively acquired and drawn between the cutting rollers for comminution.

Furthermore, an infeed having an infeed track for the product for comminution to the comminution unit is provided. This may be a type of track or chute, for example, so as to offer up the product for comminution to the comminution unit in a self-acting manner. This infeed, or the infeed track, respectively, herein should lie or run above the comminution unit, in particular at an inclination, such that the product for comminution, after having been placed or infed, for comminution slides into the comminution unit in a self-acting manner. The infeed track may terminate above the comminution unit or above the cutting gap, respectively; a spacing may advantageously be approx. 5 cm to 20 cm. An elongate piloting device which may advantageously be configured in the manner of a long protrusion or in the manner of a guide rib or the like, is disposed below the end of the infeed track and above the comminution unit, or above the cutting gap, respectively. The piloting device herein extends across a length of at least 30% of the length of the cutting rollers or of the cutting gap, respectively. Furthermore, the piloting device in the longitudinal profile thereof slopes downward from a fastening on the comminution device, or in a guide duct, respectively, to the free end of the former. An inclination angle may be 1° to 20° or even up to 45°. By way of the inclination, product for comminution that makes its way onto the piloting device may slide along the latter in a self-acting manner, and in particular in the case of particularly large product for comminution, may be guided by way of a special design embodiment of the piloting device into a specific region of the cutting rollers or of the comminution unit, respectively. In a further design embodiment of the invention, this region may then be particularly well suitable for comminuting such large product for comminution, and to this end be configured in a corresponding manner.

Thus a comminution device which above all is suitable for stable, smooth and potentially also thick product for comminution is provided by the invention. Above all, the design embodiment of the cutting discs or of the teeth, respectively, according to the invention, and the arrangement of the latter on the cutting discs and cutting rollers has proven to be advantageous for product for comminution of this type.

By way of the piloting device according to the invention it is enabled that product for comminution of dissimilar size is processed in a dissimilar manner in the comminution unit, or by being infed to different regions of the cutting rollers is in each case processed in a matching manner. On account thereof, separate infeed openings or the like, such as is the case in DE 10008442 A1, may be dispensed with.

In an advantageous design embodiment of the invention, a tooth blade of the teeth, or of the cutting discs, respectively, may have a longitudinal direction that is parallel with the longitudinal directions of the cutting rollers. This thus means that the tooth blade runs transversely to the plane of the cutting discs. The cutting rollers preferably run so as to be mutually parallel.

In an advantageous design embodiment of the invention, particularly advantageously in each position of the cutting discs or of the teeth, respectively, the teeth of directly mutually engaging adjacent cutting discs are mirror-symmetrical in relation to a central plane between the cutting rollers, said central plane also running perpendicularly to a plane in which the rotation axes of the cutting rollers lie. This means that in each rotational position of the cutting rollers, the teeth of directly mutually engaging and mutually opposite cutting discs are equally mutually spaced apart, meshing with this central plane simultaneously, so to speak. In this way the aforementioned stable or rigid, respectively, and smooth items of the product for comminution may be more positively acquired and drawn into the comminution unit.

The spacings of the teeth on a cutting disc are advantageously uniform. This applies in particular also to all cutting discs of a cutting roller, or to all cutting discs of both cutting rollers. In this way, manufacturing of the comminution device or of the cutting rollers, respectively, may be simplified.

In an advantageous design embodiment of the invention, the teeth of the cutting discs are configured such that said teeth are configured in a saw-tooth manner so as to be forwardly oblique, pointing in the rotation direction of the cutting rollers. Relatively sharp teeth of this type may acquire the mentioned product for comminution very positively, so as to draw the latter into the comminution unit or the cutting unit, respectively.

In a design embodiment of the invention it may be provided that depressions along the cutting rollers are provided in the cutting rollers or in the cutting discs, respectively, said depressions forming the aforementioned teeth, or by way of which depressions the teeth are configured. These depressions and the teeth of a cutting roller each may run along lines that run so as to be non-parallel with the longitudinal axis of the cutting roller, or that have or enclose, respectively, an angle between 1° and 10°, preferably of maximum 5°, in relation to a plane through the longitudinal axis of the cutting roller. Expressed in simple terms, the lines run as very slightly inclined spirals around the cutting rollers. By way of this profile of the depressions and of the teeth it is possible for even larger free spaces between the cutting discs or tooth blades, respectively, to be provided in the cutting gap in a region of the cutting rollers or of the comminution unit, respectively, in which the depressions in the two cutting rollers have a comparatively large mutual spacing, so to speak, and in which large items to be comminuted as the product for comminution may be particularly positively acquired for comminution.

It may yet also be provided for the piloting device according to the invention that the former covers between 30% and 70%, advantageously between 40% and 50%, of the length of the cutting gap between the cutting rollers. Said piloting device should thus not run across the entire cutting gap, since above all large product for comminution is to be moved into the comminution unit, or between the cutting rollers, respectively, in the free region. The piloting device serves this very purpose, in particular also by way of the inclination according to the invention thereof, or the oblique profile thereof, in order for the product for comminution to slide therealong in a self-acting manner. The piloting device may advantageously run directly above the cutting gap, or above the cutting rollers, respectively. Particularly advantageously, said piloting device herein may at least in regions cover a central line between the two cutting rollers.

While the piloting device in the longitudinal profile thereof is advantageously inclined toward a free end that terminates, so to speak, above the comminution unit, or above the cutting gap, respectively, said piloting device in the case of a planar design embodiment may be inclined in a direction that is transverse to the former, thus in the width direction, toward a wall of a guide duct to which said piloting device is fastened, or very close to which said piloting device runs. In this way, it may be achieved that the product for comminution does in fact slide along the piloting device up to the free end of the latter, and does not laterally slide into the comminution unit already beforehand. Such a piloting device is advantageously configured as a sheet-metal panel, particularly advantageously without openings, such that no product for comminution may catch or jam therein.

In an embodiment of the invention a guide duct may be provided between the infeed track, from above, and the comminution unit therebelow, or the cutting rollers therebelow, respectively. The infeed track herein may reach up to a side of the guide duct, wherein said infeed track advantageously runs transversely to the longitudinal direction of the cutting rollers.

It may be provided for such a guide duct that the piloting device according to the invention is disposed on that side of the guide duct that is opposite the infeed track, but in any case is disposed below the infeed track. In this way, large items to be comminuted may slide inward by way of the infeed track, initially drop onto the piloting device, then in turn slide along the latter up to a desired region above the cutting rollers. Then said items may drop downward from the piloting device into the comminution unit, or onto the cutting rollers, respectively.

A width of the piloting device may be between 30% and 70%, advantageously between 40% and 60%, of the width of the guide duct in this direction. In this way, even large items to be comminuted may be positively caught in order for these to slide along on the piloting device, while small product for comminution under certain circumstances may also drop laterally past the piloting device directly into the cutting gap, or between the cutting rollers, respectively.

The guide duct may have a length that corresponds to the cutting gap, and a width in the range of 10% to 30% of the length. In absolute dimensions, this may be a length of approx. 15 cm to 50 cm, and a width of 2 cm to 15 cm. A diameter of the cutting discs may be approx. 4 cm to 8 cm, or even 10 cm. The thickness of said cutting discs may vary between 1 mm and 10 mm.

In a method according to the invention for operating a previously described comminution device, load measurement is performed on a drive motor to the comminution unit during operation, said drive motor advantageously driving both cutting rollers, if and when product for comminution has been introduced. This is particularly advantageously performed by detecting the electric current that is required by the drive motor. In this way, it may be detected, depending on the load state of the drive motor, whether the comminution unit has acquired product for comminution. Methods of this type are known to a person skilled in the art from the prior art, and need not be explained in more detail herein. If and when it is identified herein that the comminution unit has acquired product for comminution, for example once said comminution unit has been set in operation in an automated manner by way of a light barrier or the like, said comminution unit carries out a usual comminution procedure. However, if and when it is detected by way of the load measurement that the comminution unit has not acquired an infed product for comminution, specifically by way of the load on the drive motor not having increased, the drive motor after a short period, advantageously between 1 or 2 and 20 seconds, is reversed such that the latter rotates the comminution unit in the opposite direction. The rotation direction of the cutting rollers is thus reversed as compared to the operation direction. This in turn may be performed for a short period, advantageously between 0.5 seconds and 5 to 10 seconds. On account thereof, the position of a product for comminution or of an item to be comminuted that probably already bears on the cutting rollers or on top of the cutting rollers, but has not yet been acquired by the teeth, is varied such that the latter becomes possible. The drive motor thereafter is stopped again, and the comminution unit is rotated in the normal operation direction thereof again by the drive motor. Herein, the product for comminution should then have advantageously been acquired by the teeth or by the comminution unit, respectively.

Should the product for comminution still not have been adequately positively acquired in order for the former to be drawn in, this procedure may be repeated once or multiple times, on account of which the position of the product for comminution should be modified each time, if possible. This repetition may be performed between 2 and 10 times. Should an acquisition and comminution of the product for comminution by then still not have been detected by way of load measurement, an error message or a corresponding alternative report may be issued to an operator. Thereupon, said operator has to retrieve the product for comminution, or attempt to comminute the latter in another manner.

Apart from the claims, these and further features are also derived from the description and the drawings, wherein the individual features may be implemented individually or in a plurality thereof in the form of a sub-combination in the case of an embodiment of the invention and in other fields, and may represent advantageous embodiments that per se are capable of being protected and which are claimed herein. The subdivision of the application into individual paragraphs and subtitles does not limit the statements made therebelow in terms of the general applicability of the latter.

### BRIEF DESCRIPTION OF THE DRAWINGS

Exemplary embodiments of the invention are schematically illustrated in the drawings and will be explained in more detail hereunder. In the drawings:

FIG. 1 shows a lateral sectional illustration of a comminution device according to the invention.

FIG. 2 shows an enlargement of a comminution unit of the comminution device of FIG. 1.

FIG. 3 shows a simplified illustration of the comminution unit of FIG. 2, having the cutting rollers and cutting discs, including a central plane that is illustrated with a dashed line, and

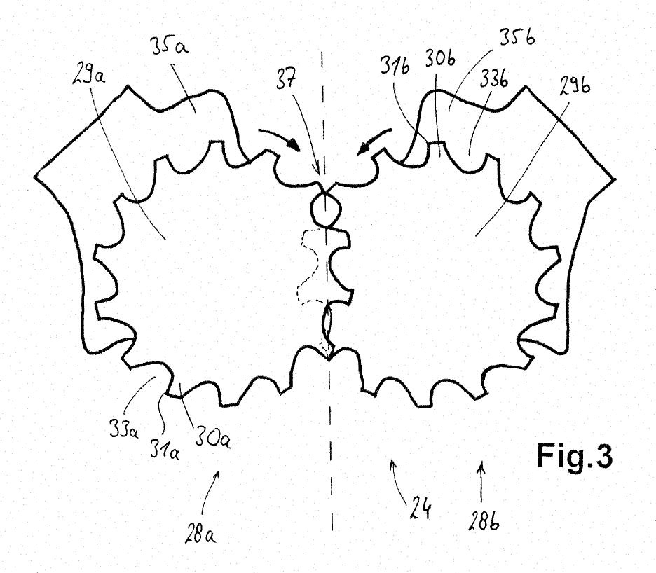

FIG. 4 shows a sectional illustration of the comminution device of FIG. 1 from above, with a view into the comminution unit.

### DETAILED DESCRIPTION OF THE EXEMPLARY EMBODIMENT

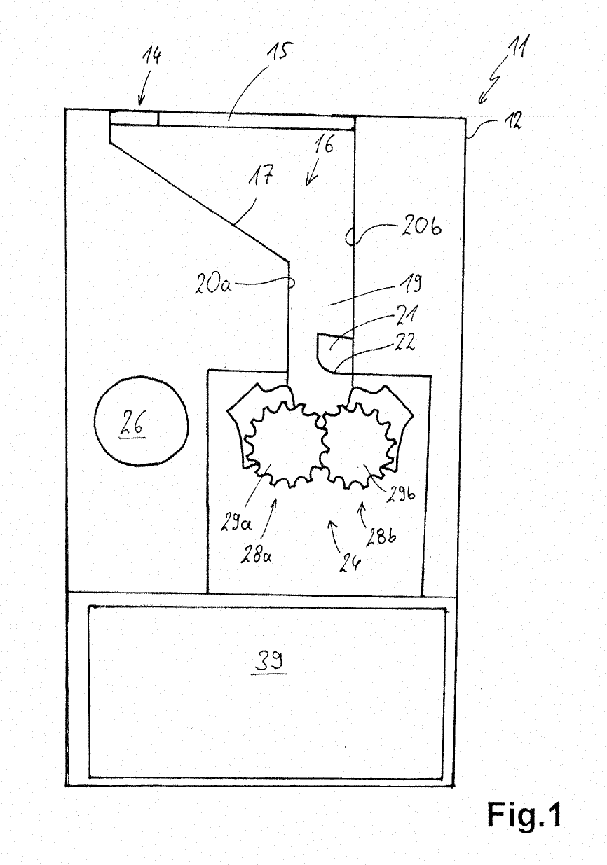

A comminution device 11 according to the invention, such as may be used in an office or a smaller enterprise, for example, for comminuting the product for comminution mentioned at the outset, or above all for destroying the digital data stored therein, respectively, is illustrated in FIG. 1. The comminution device may be approx. 0.8 m to 1.5 m in size and advantageously be operated by a usual mains connection.

The comminution device 11 has a housing 12 having a slot-type infeed opening 14 having the exemplary dimensions of 4 cm×16 cm and being long and wide enough for the product for comminution envisaged. An infeed 16 having an oblique infeed track 17 adjoins the infeed opening 14 on the upper side of the comminution device 11. Said infeed track 17 leads to a guide duct 19, or transitions directly into one of the walls 20a and 20b of the latter, respectively, specifically into the left wall 20a. The guide duct 19 herein runs vertically, but this is not mandatory. Said guide duct 19 has a width of 16 cm, like the infeed opening 14, wherein these dimensions may also well be double this size.

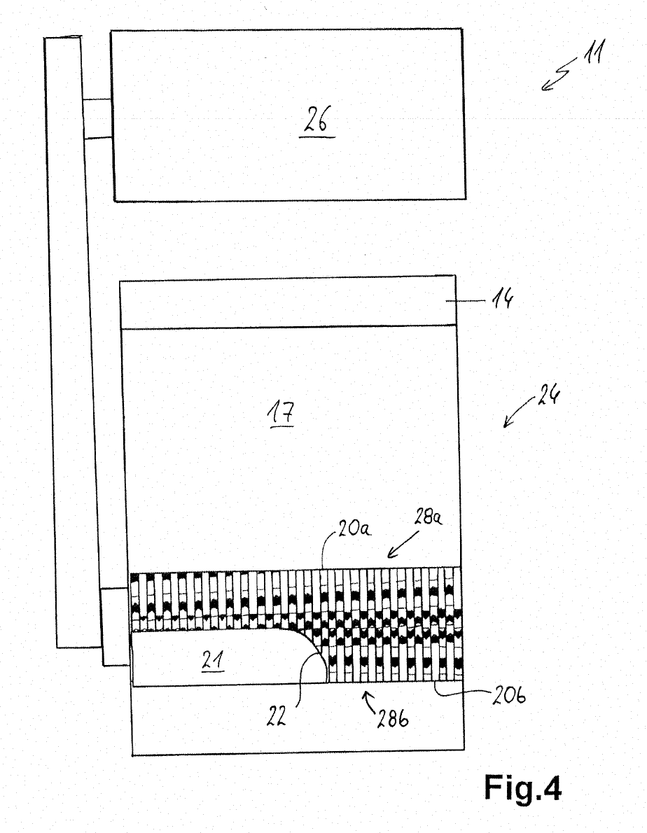

A piloting device 21 which can be better seen in the plan view of FIG. 4 is disposed at the bottom in the guide duct 19, below the infeed track 17. The piloting device 21 which here is viewed on the lower side thereof, herein is an elongate sheet-metal panel and is fastened to the right wall 20b of the guide duct 19, bearing on the latter. Said piloting device 21 herein is obliquely inclined to the right towards the wall 20b, sloped downward, or forms a type of V-shape channel with the latter, respectively. In the longitudinal extent thereof, said piloting device 21 is sloped downward into the drawing plane, as can be seen by way of the free end 22 that lies further below. A comminution unit 24 which in principle has many constructive commonalities with known comminution units or cutting units of shredders mentioned at the outset is located below the piloting device 21. The comminution unit 24 has a drive motor 26 which, as is shown on the left in FIG. 4, drives the comminution unit 24 in a known manner by way of a chain which is illustrated in a simplified manner.

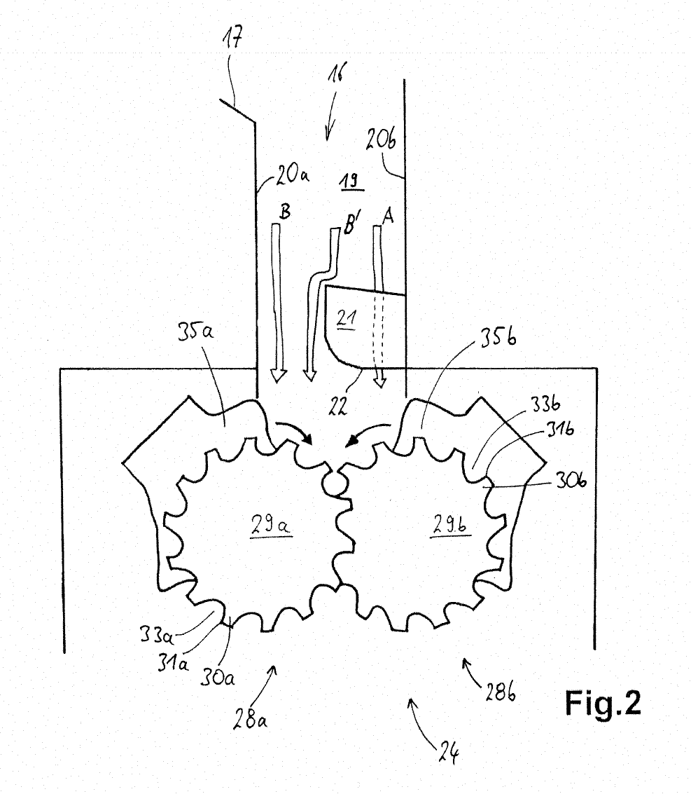

The comminution unit 24 has a left cutting roller 28a and a right cutting roller 28b, each having left cutting discs 29a and right cutting discs 29b. The cutting discs 29a and 29b each have teeth 30a and 30b, and tooth blades 31a and 31b that are provided on tooth tips. Depressions 33a and 33b are located in each case between two successive teeth of the same cutting disc, as can clearly be seen from the enlarged illustration of FIG. 2. The teeth 30a and 30b herein are inclined in the rotation direction or operation direction, respectively, of the cutting discs 29a and 29b such that said teeth 30a and 30b are configured in a saw-tooth or ripper-tooth type manner. 14 teeth 30a and 30b are provided for each cutting disc 29a and 29b. As is highlighted above all by the plan view of FIG. 4, the cutting discs 29a and 29b of the cutting rollers 28a and 28b engage in one another in a directly adjacent manner. So-called scrapers 35, specifically left scrapers 35a and right scrapers 35b, are provided as stationary narrow protrusions between the annular grooves between in each case two of the cutting discs 29 of a cutting roller 28. Said scrapers 35 are however known from the prior art, and are intended for removing particles or parts of the product for comminution from the annular grooves between the cutting discs 29.

It can also be seen in FIG. 4 how the teeth 30 and the depressions 33 run along lines which slightly diverge from the left to the right, herein at an opening angle of approx. 10° between the lines of both cutting rollers. Thus, the somewhat different opening widths exist in the right region than in the left region at any given time.

The comminution unit 24 is open towards the bottom. Collection containers or the like may be introduced in a collection space 39 that is provided below said comminution unit 24, so as to collect and accumulate the comminuted product for comminution.

A cutting gap 37 which obviously lies between the two cutting rollers 28a and 29b is illustrated in the enlarged illustration of the comminution unit 24 including the infeed 16 in FIG. 2. Herein, two teeth 30a and 30b are just about to mutually engage such that the cutting gap 37 is almost closed. It can also be readily seen from the enlargement that the cutting discs 29a and 29b overlap completely, even in the case of the depressions 33a and 33b lying on a plane on which the two rotation axes of the cutting rollers 28a and 28b lie.

A likely and desired path A for large product for comminution, for example the aforementioned mobile terminal apparatuses, is illustrated in the guide duct 19. This path A emanates from above via the infeed 16 or the infeed track 17, respectively, leading via the piloting device 21. By way of the arrangement of the piloting device 21 on the wall 20b, the latter lying opposite the infeed track 17, it is ensured that such product for comminution therefrom also lands on the piloting device 21. The product for comminution then by way of the free end 22 of the piloting device 21 slides down into the comminution unit 24, or towards the cutting gap 37, respectively. As can be seen from FIG. 4, the length of the piloting device 21 is somewhat more than half the length of the cutting gap 37, or of the length of the cutting rollers 28a and 28b, respectively. In the right region, here illustrated in FIG. 4, the opening width on the teeth 30a and 30b is somewhat larger such that large items may better be acquired and drawn into the comminution unit 24 here. This has already been discussed above. The concept and purpose of the piloting device 21 is thus to ensure that large product for comminution as far as possible arrives between the cutting rollers 28a and 28b in this right region and not in the left region.

A path B for product for comminution which slides downward on the infeed track 17, falling past the piloting device 21 on the left, into the comminution unit 24 is illustrated in FIG. 2. Said product for comminution may be memory cards or so-called SD cards, respectively, which for being drawn in and comminuted or destroyed, respectively, may readily and reliably be acquired by the comminution unit 24 or by the cutting rollers 28a and 28b, respectively.

According to the path B, even comparatively large mobile terminal apparatuses in the form of tablet computers may be infed, the latter thus also entering the comminution unit 24 by bypassing the piloting device 21. However, said comparatively large terminal apparatuses are not brought in by way of the infeed opening 14. A movable or displaceable flap 15, respectively, on which the infeed opening 14 is provided on the left, is pushed to the side for said comparatively large terminal apparatuses, thus clearing the access directly from above, bypassing the piloting device 21, into the comminution unit 24. Comminuting is no problem for tablet computers of this type, as they are rather thin and thus are reliable acquired by the cutting rollers in each region.

Finally, a path B′ in which small product for comminution may possibly also drop onto the piloting device 21, but then not slide off the latter by way of the free end 22 but slide laterally towards the outside is also illustrated. This is also envisaged in this manner and is acceptable.

A previously described method for operating the comminution device 11 according to the figures is readily imaginable by means of the figures and need not be repeated yet again in detail. A load measurement, as has been mentioned previously, is located in a power supply to the drive motor 26, said load measurement being advantageously connected to an actuator (not illustrated herein) of the comminution device 11 for the drive motor 26. It may be identified at the top of the infeed opening 14 or in the infeed 16, alternatively also on the displaceable flap 15, advantageously by way of light barriers, micro switches or the like, if and when product for comminution has been introduced. The drive motor 26 may then be started, setting the cutting rollers 28a and 28b of the comminution unit 24 in motion in the operation direction, as is indicated in FIG. 2. If after a short period, for example after the aforementioned few seconds, it is identified by means of the load measurement on the drive motor that the load has not increased, or that infed product for comminution has not yet been acquired, the procedure of reversing the rotation direction is performed for a short period. By reversing the rotation direction, the product for comminution is intended to be modified in terms of the position thereof, or the contact thereof, respectively, in relation to the cutting rollers 28a and 28b, or in relation to the teeth 30, respectively, such that acquiring is performed upon another reversal of the rotation direction to the operation direction. If and when the product for comminution has then still not been acquired, this being detectable by an unchanged low load on the drive motor 26, the procedure of reversing the rotation direction is repeated, optionally multiple times, as has been explained above.

1. A comminution device for product for comminution such as memory cards, mobile terminal apparatuses or the like, wherein
said comminution device has a comminution unit which has two interacting cutting rollers that are rotatably driven in mutually opposite directions, each having mutually intersecting cutting discs that are disposed in an alternating manner and form a cutting gap;
said cutting discs of said one cutting roller each engage in an annular groove between adjacent said cutting discs of said other cutting roller;
said cutting discs have cutting edges on external peripheral edges;
said cutting discs along an external circumference have a plurality of teeth, each said tooth having one tooth tip and one tooth blade on said tooth tip;
said teeth or said tooth blades, respectively, of said cutting discs are aligned such that the former during operation of said comminution unit upon rotation of said cutting rollers each lie beside said teeth or said tooth blades, respectively, of said other cutting roller;
said comminution device has an infeed having an infeed track for said product for comminution to said comminution unit, so as to offer up in a self-acting manner said product for comminution above said comminution unit;
said infeed track terminates above said comminution unit, or above said cutting gap, respectively, wherein an elongate piloting device is disposed below an end of said infeed track and above said comminution unit;
said piloting device extends across a length of at least 30% of a length of said cutting rollers, herein sloping downward in a longitudinal profile thereof.

2. The comminution device according to claim 1, wherein said tooth blade has a longitudinal direction that is parallel with longitudinal directions of said cutting rollers.

3. The comminution device according to claim 1, wherein said teeth of said directly mutually engaging and mutually opposite cutting discs are mirror-symmetrical in relation to a central plane between said cutting rollers, or in each rotary position of said cutting rollers are equally mutually spaced apart.

4. The comminution device according to claim 1, wherein said spacings of said teeth on one said cutting disc are uniform.

5. The comminution device according to claim 4, wherein said spacings of said teeth on one said cutting disc are uniform in the case of both said cutting rollers.

6. The comminution device according to claim 1, wherein said teeth are configured in a saw-tooth manner so as to be forwardly oblique, pointing in a rotation direction of said cutting rollers.

7. The comminution device according to claim 1, wherein depressions for forming said teeth are provided in said cutting rollers or in said cutting discs thereof, respectively.

8. The comminution device according to claim 7, wherein said depressions and said teeth of a cutting roller each run along lines that run so as to be non-parallel with a longitudinal axis of said cutting roller.

9. The comminution device according to claim 7, wherein said depressions and said teeth of one said cutting roller each run along lines that have an angle between 1° and 10° in relation to a plane through a longitudinal axis of said cutting roller.

10. The comminution device according to claim 1, wherein said piloting device covers between 30% and 70% of a length of said cutting gap between said cutting rollers.

11. The comminution device according to claim 10, wherein said piloting device runs above said cutting gap.

12. The comminution device according to claim 10, wherein said piloting device at least in regions covers a central line between said two cutting rollers.

13. The comminution device according to claim 1, wherein a guide duct is provided between said infeed track and said comminution unit or said cutting rollers, respectively, and said infeed track reaches up to a side of said guide duct, wherein said piloting device is disposed on an opposite side of said guide duct.

14. The comminution device according to claim 1, wherein a width of said piloting device is between 30% and 70% of a width of said guide duct in said direction.

15. A method for operating a comminution device according to claim 1, wherein load measurement is performed on said drive motor to said comminution unit during operation, so as to detect whether said comminution unit has acquired product for comminution, and in the case in which no acquisition of said product for comminution has been detected, said drive motor after a period between 2 seconds and 20 seconds rotates said comminution unit in an opposite direction, or reverses said rotation direction of said cutting rollers in relation to said operation direction, respectively, for a period between 0.5 seconds and 5 seconds, wherein said drive motor is subsequently stopped again, and drives said comminution unit in a normal operation direction again.

16. The method according to claim 15, wherein upon reversal of said rotation direction of said cutting rollers and re-starting said cutting rollers in said operation direction, it is again detected by way of load measurement on said drive motor whether said comminution unit has acquired said product for comminution, wherein in the case in which said comminution unit has again failed to acquire said product for comminution, operation of said comminution unit is again reversed.

17. The method according to claim 16, wherein said procedure is repeated between two and ten times.
